(19) United States
(12) Patent Application Publication
(10) Pub. No.: US 2016/0212385 A1
(43) Pub. Date: Jul. 21, 2016

(54) Real-Time Sports Advisory System Using Ball Trajectory Prediction

(71) Applicant: Sportstech LLC, Eugene, OR (US)

(72) Inventors: Matthew Leigh Ginsberg, Eugene, OR (US); Mark Cuban, Dallas, TX (US); Navarre Stephen Ginsberg, Eugene, OR (US)

(21) Appl. No.: 14/820,345

(22) Filed: Aug. 6, 2015

Related U.S. Application Data
(60) Provisional application No. 62/106,146, filed on Jan. 21, 2015.

(51) Int. Cl. H04N 7/18; G06T 7/20; A63B 71/06

(52) U.S. Cl. CPC H04N 7/183; A63B 71/0605; G06T 7/2093; G06T 7/2033; G06T 2207/30241; A63B 2220/00

(57) ABSTRACT

A sports advisory system identifies the position of a ball in a plurality of images. Based on the identified positions, a projected trajectory for the ball is determined in real time, and a prediction generated regarding a sporting outcome. A participant, such as a player, referee, or spectator, is provided with advisory information regarding the sporting outcome via a communication unit.

### CROSS REFERENCE TO RELATED APPLICATIONS

This application claims the benefit of U.S. Provisional Application No. 62/106,146, filed Jan. 21, 2015, which is incorporated herein by reference in its entirety.

### BACKGROUND

1. Technical Field

The subject matter described herein generally relates to predicting trajectories, and in particular to providing real-time information to players, referees, and spectators at sporting events based on predicted ball trajectories.

2. Background Information

Many decisions in sports relate to the trajectory of a ball or similar object, such as a puck or shuttlecock. References to a ball herein should be considered to include such similar objects. For example, when a volleyball player receives a serve, she decides whether to return it based on a prediction of whether the ball will land within or outside the court. Similarly, referees make goal-tending calls in basketball based on whether the ball has reached the peak of its trajectory at the time a player intercepts it. People typically make such decisions in the heat of the moment based on personal judgment alone. As such, there is a large degree of human error, which can promote the value of good luck over the physical aptitude of players.

### BRIEF DESCRIPTION OF THE DRAWINGS

FIG. (FIG. 1 is a high-level block diagram illustrating a networked computing environment suitable for providing advisory information based on trajectory analysis, according to one embodiment.

FIG. 2 is a symbolic representation of an implementation of a sports advisory system for volleyball, according to one embodiment.

FIG. 3 is a high-level block diagram illustrating a data processing device, such as the one in FIG. 1, according to one embodiment.

FIGS. (FIGS. 4A and 4B illustrate exemplary embodiments for fitting a parabola to a series of point locations of a ball.

FIG. 5 is a high-level block diagram of an exemplary computing device, according to one embodiment.

FIG. 6 is a flow-chart illustrating a method for providing advisory information to a sport participant, according to one embodiment.

FIG. 7 is a flow-chart illustrating a method for identifying a ball in an image, according to one embodiment.

### DETAILED DESCRIPTION

The Figures and the following description describe certain embodiments by way of illustration only. One skilled in the art will readily recognize from the following description that alternative embodiments of the structures and methods illustrated herein may be employed without departing from the principles described herein. Reference will now be made to several embodiments, examples of which are illustrated in the accompanying figures. It is noted that wherever practicable similar or like reference numbers may be used in the figures and may indicate similar or like functionality.

### Overview and Benefits

The ability to predict the trajectory of a ball (or other object) has many potential applications in sports. A player can decide whether to hit the ball or leave it based on whether it will land within or outside of the court. A referee can make more reliable judgment calls regarding potential rule violations when given accurate information describing the ball's trajectory. Fans can get more enjoyment and be more involved in the game if provided with accurate predictions of future events. Several examples will be given in the description that follows. One of skill in the art will appreciate other scenarios in which trajectory prediction may be used to provide advisory information to sport participants.

Existing systems can display the trajectory a ball actually took, and make predictions about what would have happened if a player had not interrupted the ball's path. However, such systems typically require a large number of cameras and only provide trajectory mapping after the fact. The amount of processing time required precludes providing trajectory predictions before play unfolds. For example, the HAWKEYE™ system, used is sports such as tennis and cricket, only presents information regarding ball trajectory after the passage of play in question has concluded.

In contrast, the system and method described herein can produce output before the passage of play has concluded. Thus, the system can advise a volleyball player whether a serve is going in, inform a basketball referee of the exact moment the ball reaches the peak of its trajectory, and tell baseball fans whether a ball will be fair or foul, all while the ball is in midair.

In one embodiment, a data processing device receives a plurality of digital images, each image including a ball, and identifies the position of the ball in each image. The data processing device also projects the trajectory of the ball based on the positions of the ball identified in the images. A sporting outcome is predicted based on the trajectory, and the data processing device instructs a communication unit to provide advisory information regarding the sporting outcome.

### Exemplary System

FIG. 1 shows one embodiment of a networked computing environment 100 suitable for providing advisory information based on trajectory analysis. In the embodiment shown, the networked computing environment 100 includes a recording device 110, a data processing device 120, and a communication unit 130, which communicate via networks 140 and 150. In other embodiments, the networked computing environment 100 contains different and/or additional elements. In addition, the functions may be distributed among the elements in a different manner than described herein. For example, the recording device 110 may perform some or all of the data processing.

The recording device 110 captures images that include a ball. In typical implementations, the recording device 110 captures high-definition images at a high frame rate and provides the images to the data processing device 120 rapidly. In one embodiment, a BLACKMAGIC PRODUCTION™ 4K camera is used, which captures 4000×2160 pixel images at a rate of thirty frames per second. The raw pixel data generated by the camera is available to the data processing device 120, via a THUNDERBOLT™ cable, within 150 milliseconds. In other embodiments, the recording device 110 is one or more cameras with different resolutions, frame rates, or image-output delays. In general, higher resolutions and frame rates enable more accurate ball location, and lower image-output delays allow for more rapid determination of the location of the ball in the image.

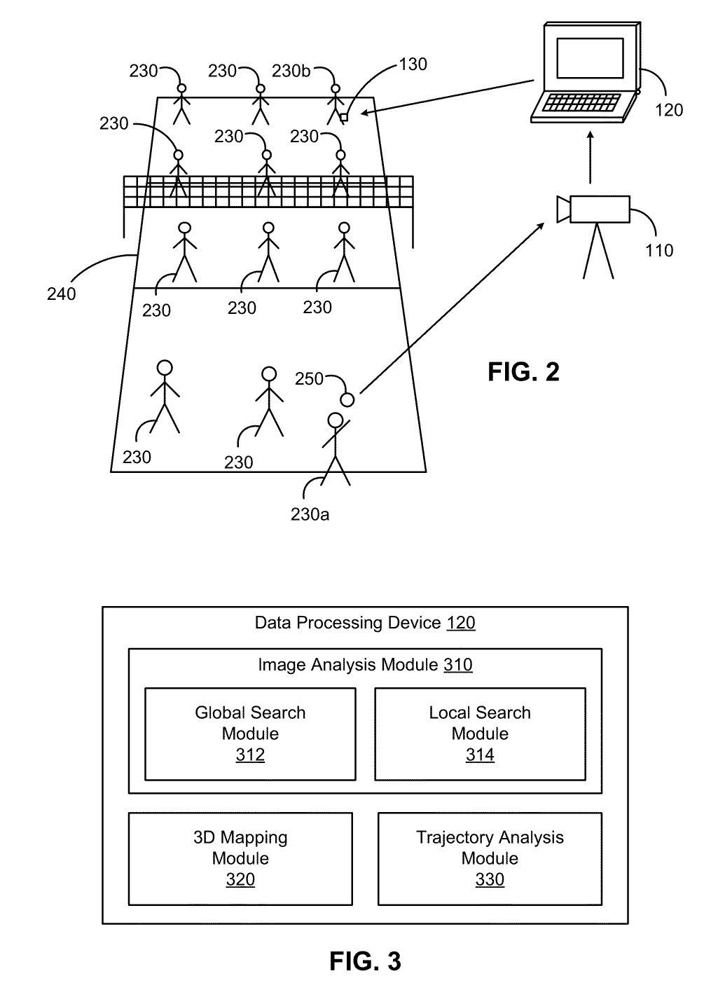

The data processing device 120 processes images received from the recording device 110 and predicts the trajectory of the ball. The data processing device 120 then sends a notification based on the predicted trajectory to the communication unit 130. In one embodiment, the data processing device 120 is a MACBOOK PRO™ laptop computer with a 2.7 GHz INTEL™ processor capable of running eight processes in parallel. In other embodiments, the data processing device 120 has different specifications. The functionality provided by the data processing device 120 is described in detail below, with reference to FIG. 3.

The communications unit 130 provides information based on the predicted trajectory to one or more individuals. In various embodiments, the communications unit 130 is a small electronic circuit and corresponding enclosure connected to an elasticated bracelet or anklet that vibrates if one or more conditions are met. In one such embodiment, an anklet worn by a volleyball player vibrates if the data processing device 120 determines an incoming ball will land outside of the court. In another embodiment, a bracelet worn by a basketball referee vibrates at the moment the ball reaches the peak of its trajectory. This indication is based on the ball's predicted trajectory, rather than detecting the time that the ball actually reaches the highest point. Consequently, it is provided to the referee at the precise moment the ball reaches the peak of its trajectory (subject to a small prediction error), automatically accounting for the communications lag between the data processing device 120 and the communications unit 130. In other embodiments, the communications unit 130 presents information based on the predicted trajectory in other ways. For example, in one embodiment, the projected trajectory is displayed or otherwise communicated (e.g., via vibration or audio tones) to one or more spectators. In this way, the spectators may be able to communicate information to players, even where the players are not equipped with communications units 130, making the fans more involved in the action. In some embodiments the communication unit is implemented in a manner available to many fans (e.g., via display on a large screen) while in others it is implemented as a specialty unit (e.g., via a limited availability application operating on a smartphone) for only select spectators. In other embodiments, other communication units are used, such as a light on the backboard that indicates when a ball has reached the top of its arc, or a smartwatch that buzzes to indicate the same condition. In another exemplary embodiment, a cone of possible trajectories is displayed to a TV audience, with the cone rapidly converging to a specific result (e.g., in or out of the basket) as the predicted trajectory becomes more certain. In yet another embodiment, the communication unit is a Samsung Galaxy S5 smartphone that communicates with the data processing device over a wireless network and that then transmits a signal to a Sony Mobile SW3 Smartwatch 3 SWR50 using Bluetooth.

The networks 140 and 150 communicatively couple the data processing device 120 with the recording device 110 and the communication unit 130, respectively. In one embodiment, the networks 140 and 150 use standard communications technologies and protocols, such as the Internet. Thus, the networks 140 and 150 can include links using technologies such as Ethernet, 802.11, worldwide interoperability for microwave access (WiMAX), 2G/3G/4G mobile communications protocols, digital subscriber line (DSL), asynchronous transfer mode (ATM), InfiniBand, PCI Express Advanced Switching, etc. Similarly, the networking protocols used on the networks 140 and 150 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), etc. The data exchanged over the networks 140 and 150 can be represented using technologies and formats including image data in binary form (e.g. Portable Network Graphics (PNG)), hypertext markup language (HTML), extensible markup language (XML), etc. In addition, all or some of the links can be encrypted using conventional encryption technologies such as secure sockets layer (SSL), transport layer security (TLS), virtual private networks (VPNs), Internet Protocol security (IPsec), etc. In another embodiment, the entities coupled via networks 140 or 150 use custom or dedicated data communications technologies instead of, or in addition to, the ones described above. Although FIG. 1 shows the various elements communicating via two networks 140 and 150, in some embodiments, the elements communicate via a single network, such as the Internet. In some embodiments, the components are directly connected using a dedicated communication line or wireless link, such as optical or RF.

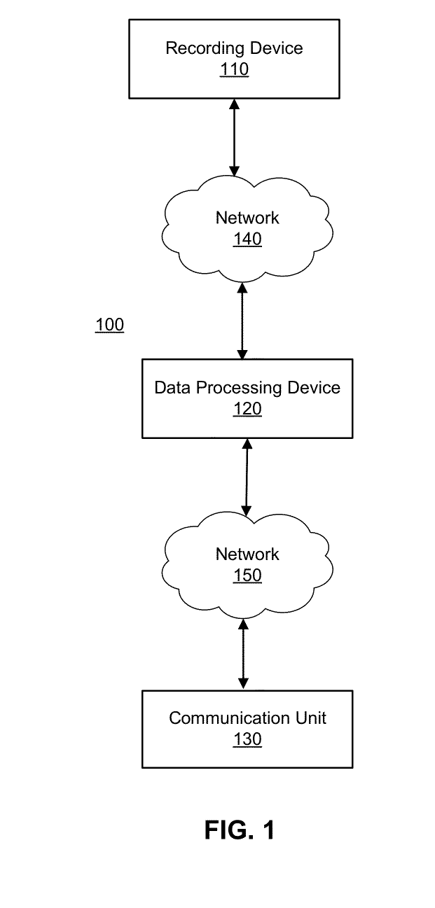

FIG. 2 illustrates an embodiment of the sports advisory system configured for use by volleyball players 230. In the embodiment show, a recording device 110 (in this case, a camera) is positioned at the side of the court 240. The camera 110 captures video frames including the ball 250 after one of the players 230a serves. A data processing device 120 (in this case, a laptop computer) analyzes the video frames to predict the trajectory of the ball 250 and determine whether it will land within the court. If the ball 250 is going out, the computer 120 notifies a communication unit 130 (in this case, attached to an anklet) worn by the receiving player 230b, which vibrates. Thus, the receiving player 230b knows the sports advisory system predicts the ball 250 will land out and can elect not to touch it.

FIG. 3 illustrates one embodiment of the data processing device 120 that predicts the trajectory of a ball by analyzing video frames including the ball. In the embodiment shown, the data processing device 120 includes an image analysis module 310, a 3D (three dimensional) mapping module 320, and a trajectory analysis module 330. The image analysis module 310 includes a global search module 312 and a local search module 314. In other embodiments, the data processing device 120 contains different and/or additional elements. In addition, the functions may be distributed among the elements in a different manner than described herein. For example, the image analysis module 310 may employ a single search module.

The image analysis module 310 analyzes video frames to identify the location of one or more balls. In one embodiment, the image analysis module employs a function, b(c,r), to determine whether or not a video frame contains a ball of a specified radius, r, at a specified point, c. To compute the value of the function, the image analysis module 310 constructs two images based on the original video frame. These images are binary maps with the same pixel dimensions as the original frame, where each pixel in the maps corresponds to the pixel in the same location in the original frame.

The image analysis module 310 constructs the first image by comparing the color of each pixel in the original video frame to an expected color of the ball. The pixels in the first image are set as on or off depending on whether the corresponding pixel in the original video frame matches the expected color of the ball within a threshold tolerance. In one embodiment, the identification of a pixel color matching a ball is done using an image in YUV coordinates, making it easy to deal with variations in the brightness of the pixel in question. In one embodiment, the color of the ball is determined by examining multiple images and evaluating possible ball colors in terms of their ability to simultaneously identify actual balls and ignore scene elements that are not balls. In one embodiment, the definition of a ball color corresponds to ranges of acceptable values for the pixel elements, such as specific ranges for the Y, U, and V values, respectively. In another embodiment, balls are permitted to be one of a plurality of colors, reflecting the fact that volleyballs (for example) are in fact tricolored. In one embodiment, the speed of the analysis is increased by restricting attention to ball centers that were not the centers of balls in other images a fixed amount of time (such as one sixth of a second) in the past.

The image analysis module 310 generates the second image by applying an edge-detection algorithm (e.g., the Canny edge detector) to the original video frame. Each pixel in the second image that corresponds to an edge in the original video frame is set to on, while the remaining pixels are set to off. Thus, the first and second images indicate pixels that are in a color range that corresponds to the ball and pixels that are an edge (i.e., a change from a region of one color to another), respectively.

In one embodiment, having generated the first and second images, the image analysis module 310 identifies regions that are likely to correspond to the ball by considering the following conditions:

(1) The edge of b(c,r-d) is all (or mostly) on in the first image for some small delta, d (approximately one pixel). This means that just inside the edge of the region corresponding to the potential ball, all (or most) of the pixels are the correct color for the ball.

(2) The edge of b(c,r) is all (or mostly) on in the second image. This means the edge-detection algorithm detected an edge for the entire (or most of) the perimeter of the potential ball.

(3) The edge of b(c,r+d) is all (or mostly) off in the first image for the small delta, d. This means that immediately outside the potential ball, the pixels are all (or mostly) not ball colored.

In practice, it is unlikely that all of the pixels considered for the three conditions will be in the expected state due to errors in the image and random fluctuations in the background or lighting. In various embodiments, the image analysis module 310 accounts for this by computing the probability for each condition that the number of pixels not in the “correct” state would occur if the overall pixels in the image were distributed randomly. The negated logarithm of these probabilities provides a score for the image for each condition. The total of these scores provides a value for the function b(c,r). Because having a large number of pixels in the correct state is a “surprise” in that for a randomly selected point in the image, you would not expect this to happen. Thus, the presence of a ball is indicated by the occurrence of an event with very low prior probability; the larger the surprise, the more likely that it represents an actual physical object. These low probability events will have very negative log(p), so the negated log of the probability is a reasonable value for the score of the event itself. Consequently, higher values of the function b(c,r) correspond to greater likelihoods that a ball is present at the corresponding location, c. In one embodiment, if multiple locations within the ball radius, r, have high likelihoods of being the location of a ball, the image analysis module 310 selects the one with the highest score. This prevents the image analysis module 310 from determining multiple overlapping balls exist where in fact only one is present.

The circles used to calculate the scores that contribute to b(c,r) may intersect a pixel through the center, barely cross one corner, or anything in between. In one embodiment, the image analysis module 310 compensates for this by assigning a weight to each that is proportional to the length of the circle and the pixel. The degree to which different circles intersect given pixels can be pre-computed to reduce the amount of calculation required during operation. In other embodiments, different methods of calculating the weighting assigned to each pixel are used.

In many implementations, the data processing device 120 is not computationally powerful enough to analyze the entirety of each frame to identify ball locations in time to provide predictions. In one embodiment, this problem is addressed by limiting the search for balls to two types of search: global and local. The global search (implemented by the global search module 312) only considers pixels surrounded by enough other pixels of the appropriate color that it is a feasible candidate for the center of a ball. The local search (implemented by the local search module 314) limits its search to a region surrounding the projected location of a ball in the current frame, based on the appearance of that (possibly moving) ball in the previous frame or frames. The global and local searches run in parallel. Whenever a global search finishes, the results are included in what the local search is doing and a new global search iteration begins. Local searches begin as soon as the previous iteration completes and a new frame is available from the recording device 110. In these local searches, the area of the image under consideration is restricted. So if the local search is based on a single previous image, it can be assumed that the ball is still reasonably close to its prior location. If based on two previous images, it can be assumed that the velocity of the ball is approximately unchanged, with the ball's likely position in the current image extrapolated from the previous position and the computed velocity. If the local search is based on three or more previous images, it can be assumed that the ball is moving in a parabolic arc in the image, and the local search can continue to focus on a relatively restricted region in which the ball can be expected to be seen.

In other embodiments, other methods of reducing the required calculation time are used. These include not analyzing locations that appear to correspond to balls that are not moving in the image (as mentioned in paragraph 0024), or not analyzing locations that appear to be substantially less likely to be actual balls than other locations. In one embodiment of this latter idea, the image analysis module 310 scans the image and estimates that there are certain locations where a high percentage (say 85%) of the surrounding pixels are ball colored. Other locations for which a lower percentage of the surrounding pixels are ball colored (say 75%) are then ignored. The percentage cutoff can be computed by: reducing a fixed percentage from the high percentage value; multiplying the high percentage value by a constant factor, or in a variety of other ways.

The 3D mapping module 320 receives output from the image analysis module 310 and determines the location of the balls identified in the images in 3D space. In various embodiments, the 3D mapping module first determines the location and orientation of the camera in 3D space based on the positions of the lines of the court (or playing field, etc.) in the images. The 3D mapping module 320 is pre-programmed with the position of lines and other markings on the court or field for the sport in question. The Canny edge detection algorithm is then used to identify lines in the image, and then the camera position and orientation parameters are varied until a good fit is found between the lines in the image and the lines expected to be present.

In one such embodiment, the 3D mapping module 320 considers two factors: (1) how many edges in the image are correctly predicted as edges on the court; and (2) how close the predicted edges are to actual edges in the image. The former factor is typically more useful when the 3D mapping module 320 already has a good approximate location of the camera. Conversely, the latter factor is typically more useful for initial attempts to determine the location and orientation of the camera. In other embodiments, different or additional factors are considered, such as the fact that the lines on physical courts are known to have specific widths, making it possible to identify specific pairs of lines corresponding to each side of a court boundary, and the fact that the hoops on a basketball court are of a known color and location in space.

In some implementations, it is not possible to consider every possible location and orientation of the camera. For example, there may be too many images to be processed given the available processing power to achieve near real-time output. This problem may be addressed by considering multiple representations of the camera position and using a gradient descent method with each to gradually improve the determined location and orientation of the camera. In other words, the data processing device 120 iteratively varies the virtual position of the camera to better map the virtual position to its actual physical position. Performing gradient descent on one representation finds a local minimum (i.e., a local best fit) of that representation, but does not guarantee that the local minimum is the global minimum. However, while the local minima of the different representations are unlikely to correspond to a single camera position, the global minima for each should appear with (approximately) the same camera location and orientation. Thus, the 3D mapping module 320 can distinguish between local minima and the global minimum by comparing two or more of the representations.

In one embodiment, the 3D mapping module 320 builds each representation based on one or more of the following: (1) the camera parameters themselves (location and orientation); (2) the location of the corners of the court (or field) in the image; (3) the selection of the lines in the image that correspond to the lines on the court; and (4) the selection of the portion of the court that is visible in the image, and its orientation (the entire court is generally not visible, since fans often obscure the near sideline, which can help distinguish an “end zone” image from a “sideline” image). The camera parameters in (1) are generally represented using nine floating point numbers, the positions of the corners in (2) correspond to four pixel locations in the image, the selection of the lines in the image (3) correspond to the identification of multiple pairs of pixel locations (each such pair corresponding to a single line), and the selection of the portion of the court visible in the image in (4) corresponds to a Boolean function labeling each known line on the court as “true” (visible in the image) or “false” (not visible in the image). Thus, the representations for these different features can be expected to differ for any given image. In other embodiments, other representations and methods of determining the location of the camera are used. For example, in one embodiment, a camera is preinstalled at a fixed location relative to the court. Thus, its precise location can be pre-calculated using the methods described herein or determined using other techniques, and then preprogrammed into the data processing device 120.

Regardless of the method used, once the 3D mapping module 320 has determined the camera location and orientation, it can map each pixel in the image to some position on a line extending from the camera lens to infinity. The 3D mapping module 320 can then locate an object (e.g., a ball) on that line (and hence determine a precise location in 3D space) based on the apparent size of the object. For example, in one embodiment, the 3D mapping module 320 is pre-programmed with the dimensions of the ball. Therefore, by comparing the apparent size of the ball in the image with the known dimensions, the 3D mapping module 320 can determine the distance between the camera and the ball. In embodiments where the ball is non-symmetric (e.g., a football, puck, or shuttlecock), the 3D mapping module 320 first determines the current orientation of the ball based on its apparent shape in the image. Once the orientation has been determined, the 3D mapping module 320 compares the ball's apparent size with an expected size for that orientation to determine the distance between the camera and the ball.

The trajectory analysis module 330 receives information about ball locations from two or more images and determines the trajectory of the ball. The trajectory analysis module 330 may work in 3D space or image space, with the 3D mapping module 320 later mapping the trajectory into 3D space as required. In one embodiment, the trajectory analysis module 330 calculates the trajectory of the ball assuming that the only force acting on it is gravity (i.e., ignoring factors such as ball spin, air resistance, and wind). Thus, the trajectory is a parabola and can be completely determined from six variables: the initial three-dimensional position and velocity vectors. Given n images from times t₁ through tₙ, the trajectory analysis module 330 has n points, with each point including an apparent ball radius, and a two-dimensional (e.g., x and y coordinates) ball center location, C₁.

In theory, two images are sufficient because only six independent data items (the two coordinates for each ball center and two apparent radii makes six data points) are required to uniquely determine the six variables that define the parabola. However, increasing the amount of data reduces the overall error, meaning more images are often required to make sufficiently accurate predictions. In one embodiment, the trajectory analysis module 330 calculates the error of the fitted parabola with the equation: e (p, v)=Σ[(cᵢ−Cᵢ)²+(rᵢ−Rᵢ)²], where e (p, v) is the error in the fitted parabola, cᵢ−Cᵢ is the difference between the predicted and observed ball center location for image nᵢ, and rᵢ−Rᵢ is the difference between the predicted and observed ball radii for image In other embodiments, the contributions to the total error of the ball center position terms and the ball radii terms are weighted differently. In other embodiments, the error that is minimized is not the disparity between the image as predicted and the image as observed (as in the above equation) but is instead the disparity between the ball positions as computed from single images and the ball positions as computed from the trajectory.

FIG. 4A illustrates a parabola 410 fitted by the trajectory analysis module 330 using three data points 412, 414, and 416 corresponding to three observed positions of the ball 250. The trajectory analysis module 330 also considered the observed radius of the ball corresponding to each data point in fitting the parabola 410. Thus, even though a slightly different parabola could be used that would pass exactly through every data point in this view, the total error is minimized by having the parabola 410 pass close by point 416. If the radii were not considered, the parabola 410 would pass right through point 416, which, assuming the error calculation including the ball radii is accurate, would be a less accurate representation of the true path of the ball 250. FIG. 4B shows a parabola 450 fitted using twelve location data points 460. Consequently, although the parabola 450 does not pass exactly through any of the data points 460, greater confidence can be placed in its accuracy.

Referring again to FIG. 3, as described above with reference to various embodiments, the trajectory analysis module 330 fits parabolas to the data obtained from images of the ball and calculates a corresponding error. In one embodiment, the trajectory analysis module 330 fits several parabolas using slightly different values for the initial position and velocity variables and the corresponding error for each. The trajectory analysis module 330 then assigns each parabola a probability based on the errors (e.g., by assuming the errors are normally distributed and the optimal fit is a one standard deviation event). Based on these probabilities, the trajectory analysis module 330 predicts the probability of a given sporting outcome. For example, by summing the probability of all parabolas that correspond to a serve landing out and normalizing to the sum of all the parabolas, the trajectory analysis module 330 can determine a probability of the serve landing out. If this probability is greater than some threshold (e.g., 90%), then the data processing device 120 signals the communications unit 130, which in one embodiment alerts the receiving player (e.g., by vibrating). The threshold can be set based on the requirements of the person to be notified. For example, spectators may want to know the most likely outcome (e.g., over 50%), whereas a professional volleyball player may wish to only leave a serve if the probability that it is out is greater than the probability that they will win the point if they play the ball (about 70%). One of skill in the art may recognize other methods by which the threshold can be determined.

In one embodiment, the trajectory analysis module 330 accounts for the spin on the ball. Spin has two separate effects on the trajectory analysis. First, a spinning ball travels more uniformly because of the gyroscopic effect, avoiding the “knuckleball” phenomenon. Second, a spinning ball accelerates due to the differing air pressure on the two sides of the ball. These two phenomena are of different relative importance in different sports.

The first effect is accounted for by the trajectory analysis module's error analysis. A ball that is “dancing around” (e.g., a knuckleball) will result in a larger error, reducing the certainty of the predictions made by the system. Thus, the parabolas computed by the trajectory analysis will be relatively poor fits for the observed data, leading to relatively less certainty in the accuracy of any particular parabola, leading to relatively less certainty in the predicted sporting outcome. This is appropriate, as the ball's physical trajectory is somewhat unknown due to the knuckleball effect.

The second effect introduces an additional force into the calculations performed by the trajectory analysis module 330. In one embodiment, the trajectory analysis module 330 assumes the spin on the ball is constant and treats it as another variable to be used in fitting a trajectory to the observed data. It uses modified equations of motion that include a spin term, which is an additional acceleration vector orthogonal to both the spin vector and the direction of motion. The magnitude of this acceleration is a sport-dependent constant times the magnitude of the spin vector. For example, a tennis ball hit with topspin will dip down towards the court faster than a ball that is not spinning Thus, the trajectory analysis module 130 in some embodiments uses the observed amount of spin for a particular ball to compute the degree to which the ball will dip below the trajectory expected for a non-spinning tennis ball. This computation can be based on an analysis of a variety of balls with a variety of spins, thereby determining the quantitative impact that spin has on balls in flight generally. In one embodiment, comparisons of predicted and actual outcomes are used as feedback to improve the model used to account for spin in a given sport over time.

In some sports, air resistance is also an important factor. For example, shuttlecocks in badminton experience significant aerodynamic drag and thus do not follow parabolic paths. Rather, they slow down through the air and drop to earth faster than a typical ball following an approximately parabolic path. In one embodiment, this is accounted for by pre-programing the trajectory analysis module 330 with equations of motion that include an additional term for aerodynamic drag. This term is sport dependent and typically proportional to the current speed of the ball (or shuttlecock, etc.).

In other embodiments, the trajectory analysis module 330 accounts for other forces acting on the ball with modified equations of motion that include terms for each force. One of skill in the art will recognize techniques for modelling forces and accounting for them in the equations of motion.

### Computing System Architecture

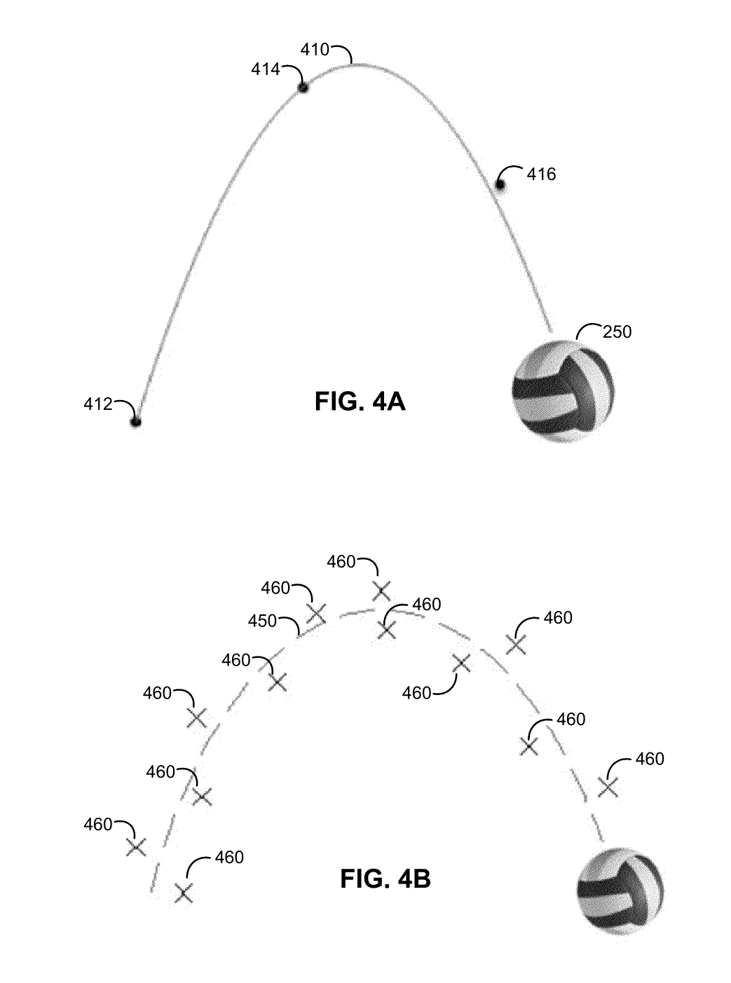

FIG. 5 is a high-level block diagram illustrating an example computer 500 suitable for use in the networked computing environment 100. The example computer 500 includes at least one processor 502 coupled to a chipset 504. The chipset 504 includes a memory controller hub 520 and an input/output (I/O) controller hub 522. A memory 506 and a graphics adapter 512 are coupled to the memory controller hub 520, and a display 518 is coupled to the graphics adapter 512. A storage device 508, keyboard 510, pointing device 514, and network adapter 516 are coupled to the I/O controller hub 522. Other embodiments of the computer 500 have different architectures.

In the embodiment shown in FIG. 5, the storage device 508 is a non-transitory computer-readable storage medium such as a hard drive, compact disk read-only memory (CD-ROM), DVD, or a solid-state memory device. The memory 506 holds instructions and data used by the processor 502. The pointing device 514 is a mouse, track ball, or other type of pointing device, and is used in combination with the keyboard 510 to input data into the computer system 500. The graphics adapter 512 displays images and other information on the display 518. The network adapter 516 couples the computer system 500 to one or more computer networks, such as networks 140 and 150.

The types of computers used by the entities of FIGS. 1-3 can vary depending upon the embodiment and the processing power required by the entity. For example, the communication unit 130 in some embodiments is a lower-powered device and lacks a keyboard 510, graphics adapter 512, and display 518, and provides information to the wearer via tactile feedback. In contrast, the data processing device 120 in many embodiments is a high-performance, multi-processor system optimized for graphical processing.

### Exemplary Methods

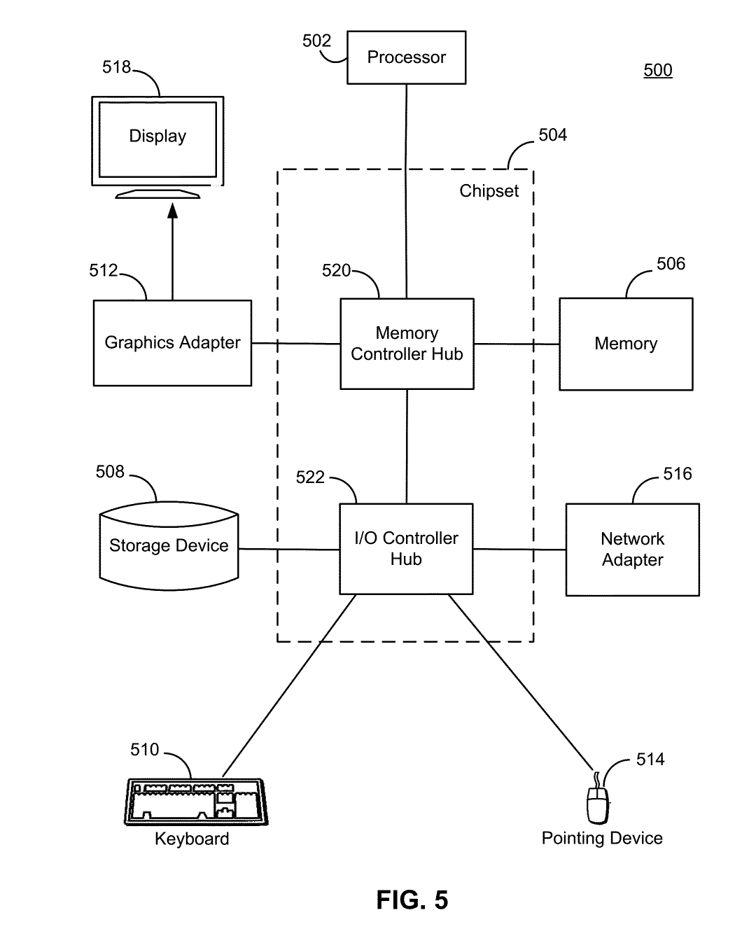

FIG. 6 shows one embodiment of a method 600 for providing advisory information to a sport participant. The steps of FIG. 6 are illustrated from the perspective of the data processing device 120 performing the method 600. However, some or all of the steps may be performed by other entities or components. In addition, some embodiments may perform the steps in parallel, perform the steps in different orders, or perform different steps. For example, the data processing device 120 may provide trajectory information to the communication device 130, which then predicts a sporting outcome that will result from the predicted trajectory.

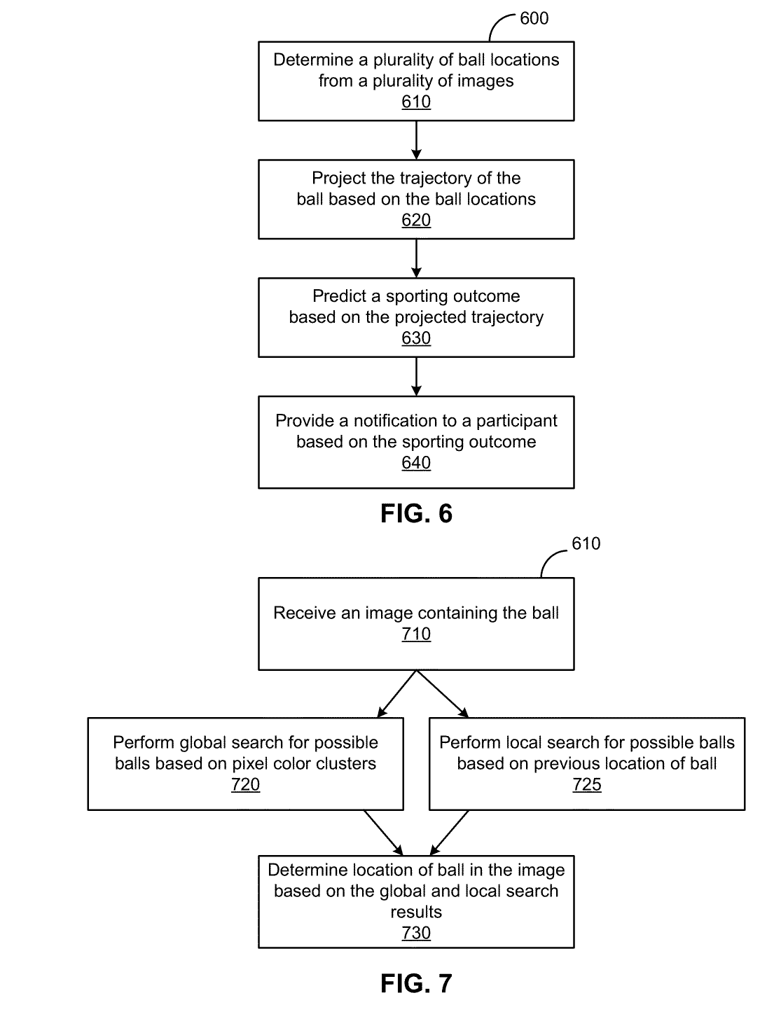

In the embodiment shown in FIG. 6, the method 600 begins with the data processing device 120 determining 610 a plurality of ball locations in a plurality of images. As described previously, using more images and locations enables greater prediction accuracy, but this should be balanced against the need to provide the advisory information in time for the player, referee, or spectator to react accordingly. The appropriate balance of prediction accuracy and data processing time in any given scenario depends on numerous factors, including the specific sport, the nature of the advisory information, the processing power available, and the preference of the individual receiving the advisory information. In one embodiment, the locations include x and y coordinates, and an apparent ball radius, which is used as a proxy for a z coordinate, as described previously. An exemplary method for determining 610 the plurality of ball locations is described in detail below, with reference to FIG. 7.

Referring again to FIG. 6, the data processing device 120 projects 620 the trajectory of the ball based on the ball locations. In one embodiment, as described above, with reference to FIG. 3, the data processing device 120 maps multiple trajectories to the ball locations and computes a probability for each one.

Based on the projected trajectory, the data processing device 120 predicts 630 a sporting outcome. In an embodiment where the projected trajectory includes multiple possible trajectories and corresponding probabilities, the data processing device divides the possible trajectories into groups that correspond to different sporting outcomes. For example, in volleyball, the data processing device 120 may group the trajectories into two groups; ball in and ball out. Thus, the probability that the ball will land in or out can be computed by summing the probabilities of the trajectories in the corresponding group and normalizing to the whole. In another embodiment, the sporting outcome is the actual trajectory of the ball (e.g., where will a basketball rebound head?). Therefore, the data processing device 120 selects the trajectory with the highest probability.

In FIG. 6, the method 600 concludes with the data processing device 120 instructing the communication unit 130 to notify a participant of the porting outcome. In one embodiment, where the sporting outcome is whether a ball is in or out, the communication unit 130 similarly provides binary feedback. For example, a player's wrist or ankle unit can vibrate for out and do nothing for in. Similarly, a light on a scoreboard or handheld device can illuminate to indicate the precise moment at which a basketball reaches the peak of its arc. Thus, the spectators or referee can immediately know whether a player is guilty of illegal goaltending. In other embodiments, the notification is more complex. For example, shortly after a basketball player releases the ball for a three point shot, a big screen can display the projected trajectory and indicate whether the shot is going in. This can increase excitement for spectators and also assist players decide whether to prepare for a rebound or head to the other end of the court for a quick counter. In one embodiment, the time between the capture of the first image by the recording device 110 and the notification being provided by the communication unit 130 is no more than half a second. Thus, the recipient is notified of the predicted sporting outcome while the recipient still has time to act in accordance with the prediction. One of skill in the art will recognize other ways in which notifications of sporting outcomes can be presented to players, officials, and spectators.

FIG. 7 shows one embodiment of a method 610 for identifying a ball in an image. The steps of FIG. 6 are illustrated from the perspective of the image analysis module 310 performing the method 610. However, some or all of the steps may be performed by other entities or components. In addition, some embodiments may perform the steps in parallel, perform the steps in different orders, or perform different steps. For example, individual dedicated computing devices may perform the global and local searches, with a third computing device processing and sharing the results as needed.

In the embodiment shown in FIG. 7, the method 610 begins with the image analysis module 310 receiving 710 an image containing the ball. The method 610 then proceeds by performing a global search 720 and a local search 725 in parallel to identify potential locations for the ball. As described previously, with reference to FIG. 3, the global search 720 analyzes regions of the image that include enough pixels of approximately the same color as the ball that it is feasible for the ball to be in that region. Also as described with reference to FIG. 3, the local search 725 analyzes a region of the image corresponding to the location if the ball in a previous image. In one embodiment, the local search also considers the apparent velocity of the ball based on its position in two or more previous images. In other embodiments, different or additional methods are used to identify potential locations for the ball.

The image analysis module 310 determines 730 the location of the ball based on the results of the local and global searches 720 and 725. In one embodiment, each potential location for the ball is assigned a probability based on the degree to which the size, shape, and color of the region of pixels corresponding to the potential location. The image analysis module 310 then selects the most likely location as the determined location. In other embodiments, the image analysis module 310 uses other methods for determining which of the potential locations corresponds to the actual location of the ball, or allows multiple balls to be located within the image.

### Additional Considerations

Some portions of above description describe the embodiments in terms of algorithmic processes or operations. These algorithmic descriptions and representations are commonly used by those skilled in the data processing arts to convey the substance of their work effectively to others skilled in the art. These operations are understood to be implemented by hardware systems or subsystems. One of skill in the art will recognize alternative approaches to provide the functionality described herein.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the disclosure. This description should be read to include one or at least one and the singular also includes the plural unless it is obvious that it is meant otherwise.

Upon reading this disclosure, those of skill in the art will appreciate still additional alternative structural and functional designs for a system and a process for predicting the trajectory of a ball and providing corresponding information to a player, referee, or spectator. Thus, while particular embodiments and applications have been illustrated and described, it is to be understood that the described subject matter is not limited to the precise construction and components disclosed herein and that various modifications, changes and variations which will be apparent to those skilled in the art may be made in the arrangement, operation and details of the method and apparatus disclosed herein. The scope of the invention is to be limited only by the following claims.

1. A system for providing advisory information regarding a sporting outcome, the system comprising:
a camera that captures a plurality of images, each of a plural subset of the images including a ball;
a data processing device coupled to the camera via a low-latency data connection, the data processing device configured to identify a position of the ball in each of the plural subset of the images, project one or more possible trajectories of the ball based on the positions, and predict a sporting outcome based on the projected one or more trajectories; and
a communication unit coupled to the data processing device via a second data connection, the communication unit configured to provide the advisory information to a sporting participant based on the predicted sporting outcome.

2. The system of claim 1, wherein the communication unit provides the advisory information via at least one of: visual feedback, audible feedback, or tactile feedback.

3. The system of claim 1, wherein the low-latency data connection provides raw pixel data corresponding to a first one of the plurality of images to the data processing device within 150 milliseconds of the raw pixel data being captured by the camera.

4. The system of claim 1, wherein the advisory information is provided by the communication unit within half a second of a first one of the plurality of images being captured by the camera.

5. The system of claim 1, wherein each of the plurality of images has a resolution of at least 4000 pixels on a first axis and 2160 pixels on a second axis, and the camera captures the plurality of images at a rate of at least thirty frames per second.

6. The system of claim 1, wherein the data processing device is a computer with a processor speed of at least 2.7 gigahertz that is capable is running at least eight processes in parallel.

7. The system of claim 1, wherein the position of the ball in an image comprises an x coordinate, a y coordinate, and an apparent size of the ball.

8. The system of claim 1, wherein each of the one or more possible trajectories are one of: a parabola, a parabola adjusted to account for a spin on the ball, or a parabola adjusted to account for air resistance.

9. The system of claim 1, wherein the sporting outcome comprises one of: a ball landing in, a ball landing out, a shot going in, a shot missing, a probable trajectory of the ball, or a ball reaching a vertical peak of its trajectory.

10. The system of claim 1, wherein the sporting participant is one of: a player, a referee, a spectator, or a TV viewer.

11. The system of claim 1, wherein the ball is one of: a volleyball, a tennis ball, a basketball, a hockey puck, a shuttlecock, a football, a cricket ball, a golf ball, or a soccer ball.

12. A computer-implemented method for providing advisory information regarding a sporting outcome, the method comprising:
receiving a plurality of digital images from a camera, each of a plural subset of the images including a ball;
identifying a position of the ball in each of the plural subset of the images;
projecting one or more possible trajectories of the ball based on the positions;
predicting a sporting outcome based on the projected one or more trajectories; and
sending an instruction to a communication unit to provide the advisory information regarding the sporting outcome.

13. The method of claim 12, wherein identifying the position of the ball in an image includes performing a global search, the global search comprising:
identifying one or more expected colors of the ball in the image;
identifying one or more regions in the image that include at least a predetermined fraction of pixels matching the expected colors within a threshold tolerance; and
searching the one or more regions for pixel configurations likely to be the ball.

14. The method of claim 12, wherein identifying the position of the ball in an image includes performing a local search, the local search comprising:
identifying a region of the image based on a location of the ball in one or more previous images; and
searching the region for pixel configurations likely to be the ball.

15. The method of claim 12, wherein identifying the position of the ball in an image comprises:
identifying a plurality of potential ball positions; and
selecting one of the plurality of potential ball positions as the position of the ball.

16. The method of claim 12, wherein projecting the one or more possible trajectories of the ball comprises:
fitting a plurality of curves to the identified positions of the ball; and
calculating an error corresponding to each curve.

17. The method of claim 16, wherein the curves are one of: parabolas, parabolas adjusted to account for a spin on the ball, or parabolas adjusted to account for air resistance.

18. The method of claim 16, wherein predicting the sporting outcome comprises:
grouping the plurality of curves into a plurality of groups, the group a given curve is placed in based on whether the given curve corresponds to a first sporting outcome or a second sorting outcome; and
selecting the first sporting outcome as the predicted sporting outcome based on the probabilities of the curves in each group.

19. A non-transitory computer-readable medium storing computer program code for providing advisory information regarding a sporting outcome, the computer program code, when executed, causing one or more processors to perform operations, the operations comprising:
receiving a plurality of digital images from a camera, each of a plural subset of the images including a ball;
identifying a position of the ball in each of the plural subset of the images;
projecting one or more possible trajectories of the ball based on the positions;
predicting a sporting outcome based on the projected one or more trajectories; and
sending an instruction to a communication unit to provide the advisory information regarding the sporting outcome.

20. The non-transitory computer-readable medium of claim 19, wherein:
projecting the one or more possible trajectories of the ball comprises:
fitting a plurality of curves to the identified positions of the ball; and
calculating an error corresponding to each curve; and
predicting the sporting outcome comprises:
grouping the plurality of curves into a plurality of groups, the group a given curve is placed in based on whether the given curve corresponds to a first sporting outcome or a second sorting outcome; and
selecting the first sporting outcome as the predicted sporting outcome based on the probabilities of the curves in each group.
